(19) United States
(12) Patent Application Publication
(10) Pub. No.: US 2024/0227970 A9
(43) Pub. Date: Jul. 11, 2024

(54) ELECTRIC KICK SCOOTER WITH REMOVABLE TRACK ASSEMBLY

(71) Applicant: Lukasz Adam Mydlarz, Breslau (CA)

(72) Inventor: Lukasz Adam Mydlarz, Breslau (CA)

(21) Appl. No.: 18/493,088

(22) Filed: Oct. 24, 2023

Related U.S. Application Data
(60) Provisional application No. 63/418,777, filed on Oct. 24, 2022.

(51) Int. Cl. B62K 11/00; B62D 55/02; B62D 55/30; B62K 3/00

(52) U.S. Cl. CPC B62K 11/00; B62D 55/02; B62D 55/30; B62K 3/002; B62K 2202/00

(57) ABSTRACT

A kick scooter includes: (a) a standing platform for supporting an operator, the standing platform having a top surface; (b) a drive wheel coupled to the standing platform; (c) a track assembly, pivotably coupled to the standing platform, for propelling the kick scooter, and the track assembly including a tensioner wheel and a continuous track that wraps around the tensioner wheel and the drive wheel, and the continuous track being driven by the drive wheel and supported by the tensioner wheel; (d) a biasing member mounted to the top surface of the standing platform and coupled to the track assembly, for biasing the track assembly downwards; and (e) an electric motor for driving the drive wheel.

### CROSS-REFERENCE TO RELATED APPLICATIONS

This application claims benefit of U.S. Provisional Patent Application No. 63/418,777, entitled “ELECTRIC KICK SCOOTER WITH REMOVABLE TRACK ASSEMBLY”, filed on Oct. 24, 2022. The entire contents of U.S. Provisional Patent Application No. 63/418,777 are hereby incorporated herein by reference for all purposes.

### FIELD

The embodiments disclosed herein relate to electric scooters, and, in particular, to electric kick scooters with removable track assemblies.

### INTRODUCTION

Travelling by electric scooter in the winter months can be difficult and dangerous since electric scooters with two wheels are not well-equipped for travelling through snow, slush, ice, and other winter conditions. There is a need for an electric scooter that is equipped to travel in winter conditions.

### SUMMARY

According to some aspects, a kick scooter, includes: (a) a standing platform for supporting an operator, the standing platform having a top surface; (b) a drive wheel coupled to the standing platform; (c) a track assembly, pivotably coupled to the standing platform, for propelling the kick scooter, the track assembly including a tensioner wheel and a continuous track that wraps around the tensioner wheel and the drive wheel, the continuous track being driven by the drive wheel and supported by the tensioner wheel; (d) a biasing member mounted to the top surface of the standing platform and coupled to the track assembly, for biasing the track assembly downwards; and (e) an electric motor for driving the drive wheel.

In some examples, the drive wheel has a rotational axis about which the drive wheel rotates, and wherein the track assembly pivots about the rotational axis of the drive wheel.

In some examples, the track assembly is positioned rearward of the standing platform.

In some examples, the electric motor is housed within the driving wheel.

In some examples, the tensioner wheel is a roller wheel.

In some examples, the drive wheel is a spoke wheel.

In some examples, the tensioner wheel promotes contact between the continuous track and drive wheel.

In some examples, the kick scooter further includes a front wheel, coupled to the standing platform, for providing the operator with steering control and supporting the kick scooter.

In some examples, the kick scooter further includes a front ski, coupled to the standing platform, for providing the operator with steering control and supporting the kick scooter.

In some examples, the biasing member comprises a coil spring.

In some examples, the biasing member comprises a damper.

According to some aspects, a method of converting a kick scooter from a wheeled configuration to a tracked configuration, the kick scooter having a standing platform for supporting an operator, the standing platform having a top surface, a rear wheel coupled to the standing platform, and an electric motor for driving the rear wheel, the method comprising: (a) removing the rear wheel of the kick scooter; (b) installing a track assembly at the previous position of the rear wheel, the track assembly comprising: a drive wheel, a tensioner wheel, a continuous track that wraps around the tensioner wheel and the drive wheel, the continuous track being driven by the drive wheel and supported by the tensioner wheel, and a biasing member; and (c) fastening the biasing member to the top surface of the standing platform.

These and other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 is a perspective view of a kick scooter, according to an embodiment.

FIG. 2 is a perspective view of the kick scooter of FIG. 1, shown with a ski attachment, according to an embodiment.

FIG. 3 is a detailed view of the biasing member of the kick scooter of FIG. 1.

FIG. 4 is a detailed view of a biasing member cover, according to an embodiment.

FIG. 5 is a detailed view of a track cover, according to an embodiment.

FIG. 6 is a detailed view of a track cover, according to an embodiment.

FIG. 7 is a detailed view of a track cover, according to an embodiment.

FIG. 8 is a detailed view of a track cover, according to an embodiment.

FIG. 9 is a perspective view of a kick scooter, according to an embodiment.

FIG. 10 is a flow chart of a method of converting a kick scooter from a wheeled configuration to a tracked configuration, according to an embodiment.

Further aspects and features of the example embodiments described herein will appear from the following description taken together with the accompanying drawings.

### DESCRIPTION OF VARIOUS EMBODIMENTS

Various systems, devices and methods are described below to provide an example of at least one embodiment of the claimed subject matter. No embodiment described below limits any claimed subject matter and any claimed subject matter may cover systems, devices and methods that differ from those described below. The claimed subject matter are not limited to systems, devices and methods having all of the features of any one systems, device or method described below or to features common to multiple or all of the systems, devices and methods described below. It is possible that a system, device or method described below is not an embodiment of any claimed subject matter. Any subject matter that is disclosed in a system, device or method described herein that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

It should be noted that terms of degree such as “substantially”, “about” and “approximately” as used herein mean a reasonable amount of deviation of the modified term such that the end result is not significantly changed. These terms of degree should be construed as including a deviation of the modified term, such as 1%, 2%, 5%, or 10%, for example, if this deviation does not negate the meaning of the term it modifies.

As used herein and in the claims, two or more parts are said to be “coupled”, “connected”, “attached”, “joined”, “affixed”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, “directly joined”, “directly affixed”, or “directly fastened” where the parts are connected in physical contact with each other. As used herein, two or more parts are said to be “rigidly coupled”, “rigidly connected”, “rigidly attached”, “rigidly joined”, “rigidly affixed”, or “rigidly fastened” where the parts are coupled so as to move as one while maintaining a constant orientation relative to each other. None of the terms “coupled”, “connected”, “attached”, “joined”, “affixed”, and “fastened” distinguish the manner in which two or more parts are joined together.

Furthermore, the recitation of any numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation up to a certain amount of the number to which reference is being made, such as 1%, 2%, 5%, or 10%, for example, if the end result is not significantly changed.

The following description is not intended to limit or define any claimed or as yet unclaimed subject matter. Subject matter that may be claimed may reside in any combination or sub-combination of the elements or process steps disclosed in any part of this document including its claims and figures. Accordingly, it will be appreciated by a person skilled in the art that an apparatus, system or method disclosed in accordance with the teachings herein may embody any one or more of the features contained herein and that the features may be used in any particular combination or sub-combination that is physically feasible and realizable for its intended purpose.

Recently, there has been growing interest in developing new electric scooters.

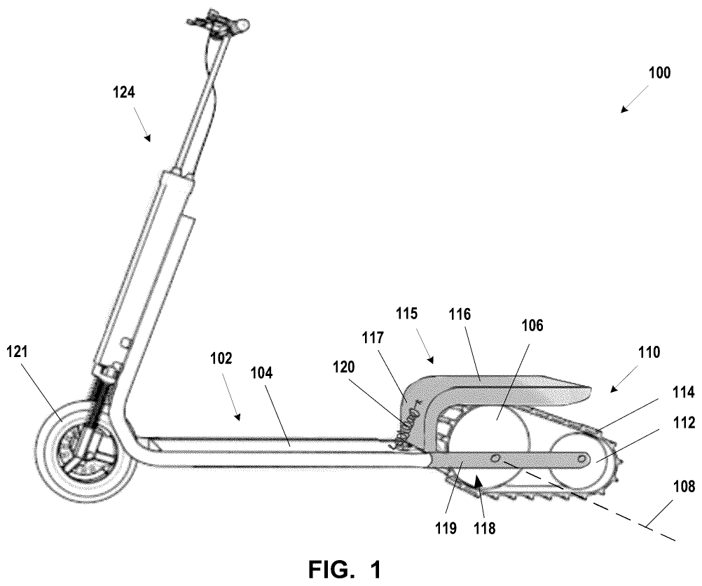

Reference is now made to FIG. 1, which shows a perspective view of a kick scooter 100, according to an embodiment. The kick scooter 100 has a standing platform 102. The standing platform 102 is for supporting an operator of the kick scooter 100. The standing platform 102 has a top surface 104. When the kick scooter 100 is in use, the operator stands on the top surface 104.

The standing platform 102 is coupled to a drive wheel 106. The drive wheel 106 is driven by an electric motor (not shown). The electric motor may be housed within the drive wheel 106. The drive wheel 106 may rotate about an axis 108. The drive wheel 106 may be a spoke wheel.

The standing platform 102 is pivotably coupled to a track assembly 110. The track assembly 110 may be positioned rearward of the standing platform 102. The track assembly 110 propels the kick scooter. The track assembly 110 includes a tensioner wheel 112. The tensioner wheel 112 may be a roller wheel.

The track assembly 110 also includes a continuous track 114 that wraps around the tensioner wheel 112 and the drive wheel 106. The continuous track 114 is driven by the drive wheel 106 and supported by the tensioner wheel 112. The continuous track 114 may rotate about the axis 108. The tensioner wheel 112 may promote contact between the continuous track 114 and the drive wheel 106.

The track assembly 110 also includes a track cover 115. In the embodiment shown in FIG. 1, the track cover 115 is generally L-shaped and has a horizontal portion 116 and a vertical portion 117. The vertical portion extends vertically upwards from the top surface 104 of the standing platform 102. The horizontal portion 116 extends horizontally outwards from the vertical portion 117 to at least partially cover the drive wheel 106 and continuous track 114. A user of the kick scooter 100 may rest their foot on the track cover 115 for balance and support. The track cover 115 may also shield the user of the kick scooter 100 from any debris which may be thrown into the air by the continuous track 114. The track cover 115 also protects the drive wheel and motor from damage.

The track assembly also includes a wheel support 118. In the embodiment shown in FIG. 1, the wheel support 118 includes a pair of wheel support members 119. The pair of wheel support members 119 extend from the standing platform 102. The wheel support members 119 are coupled to the drive wheel 106 and the tensioner wheel 112 on both of their sides.

The kick scooter 100 further comprises a biasing member 120. The biasing member 120 is mounted to the top surface 104 of the standing platform 102. The biasing member 120 is also coupled to the track assembly 110. The biasing member 120 allows for biasing of the track assembly 110 downwards. In the embodiment shown in FIG. 1, the biasing member 120 is coupled to the vertical portion 120 of the track cover 115.

In the embodiment shown in FIG. 1, the kick scooter 100 includes a front wheel 121. The front wheel 121 is coupled to the standing platform 102. The front wheel 121 provides the operator of the kick scooter 100 with steering control. The front wheel 121 also supports the kick scooter 100.

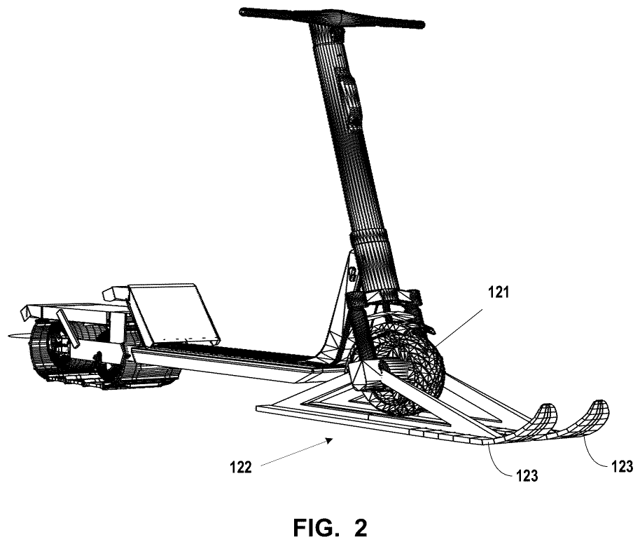

In another embodiment shown in FIG. 2, the kick scooter 100 comprises a front ski attachment 122. The front ski attachment 122 comprises two skis 123. The front ski attachment 122 is coupled to the front wheel 121. The front ski attachment 122 provides the operator of the kick scooter 100 with steering control and supports the kick scooter 100.

Referring back to FIG. 1, the kick scooter 100 also includes a handle assembly 124. The handle assembly 124 extends upwards from the standing platform 102 and is coupled to the front wheel 121. The handle assembly includes a brake lever and accelerator, providing the operator of the kick scooter 100 with steering and speed control.

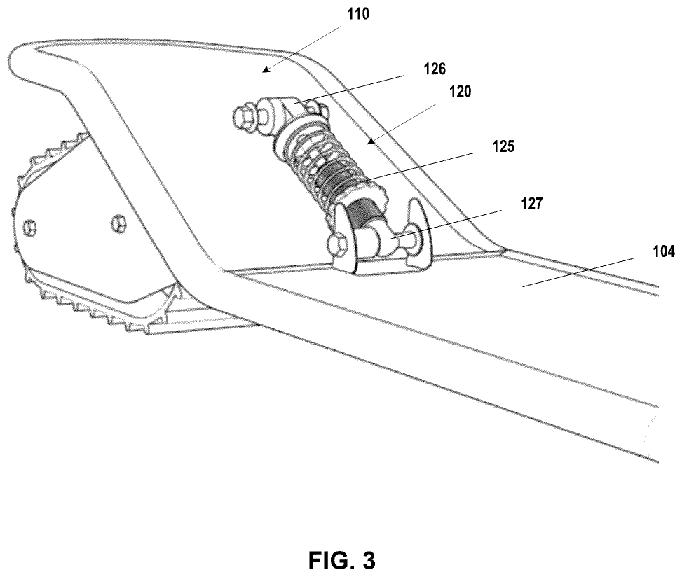

Referring now to FIG. 3, depicted is a biasing member 120, according to an embodiment. The biasing member 120 comprises a damper 125. It should be understood that biasing member 120 may be any mechanism appropriate for biasing the track assembly 110 downwards, including but not limited to a damper and a coil spring. The damper 125 has a first end 126 and a second end 127. The damper 125 is mounted to the top surface 104 of the standing platform 102 towards the second end 127. The damper 125 is coupled to the track assembly 110 towards the first end 126.

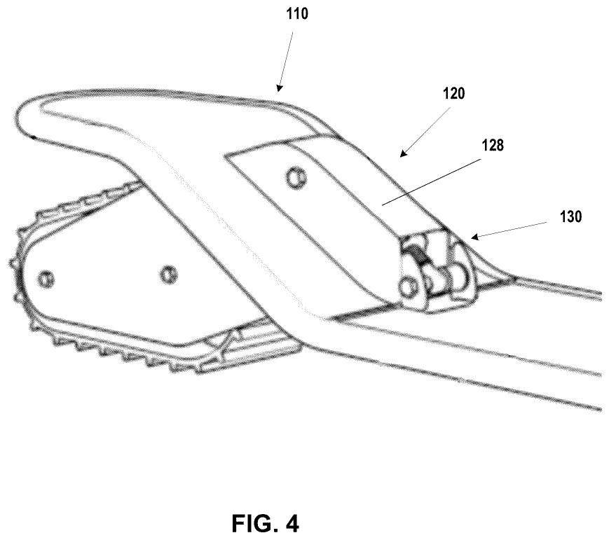

Referring now to FIG. 4, depicted is the biasing member 120, in accordance with an embodiment. The biasing member 120 is the damper 125 and has a biasing member cover 128. The biasing member cover 128 encloses the damper 125 to shield the damper 125 from damage caused by, for example, the operator, snow or rain. In the embodiment shown, biasing member cover 128 has an opening 130 towards the second end 127 of the damper 125 to accommodate the motion of the track assembly 110.

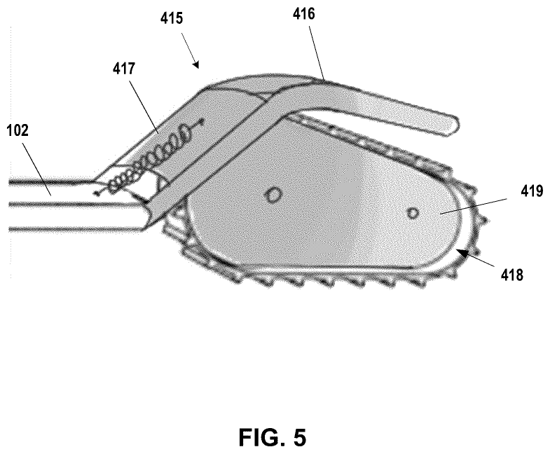

FIGS. 5 through 7 show alternative embodiments of the track cover 115 and wheel support 118. Referring to FIG. 5, illustrated therein is a track cover 415, according to an embodiment. The track cover 415 includes a horizontal portion 416 and an angled portion 417. The angled portion 417 extends up and away from the top surface 104 of the standing platform 102, towards the track assembly 110. The horizontal portion 416 extends generally horizontally away from the angled portion 417 to at least partially cover the drive wheel 106 and continuous track 114. A wheel support 418 comprises a pair of side panels 419. The pair of side panels 419 are mounted to the track cover 415. The side panels 419 are coupled to the drive wheel 106 and the tensioner wheel 112 on both of their sides. The side panels 419 are shaped to cover the sides of the drive wheel 106 and tensioner wheel 112.

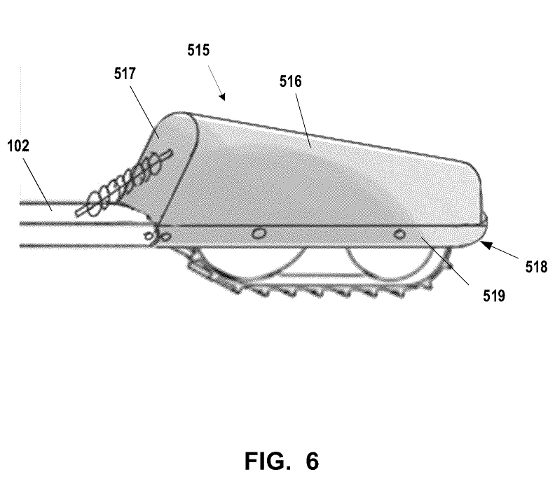

Referring to FIG. 6, depicted is a track cover 515, according to an embodiment. The track cover 515 includes a housing 516, a front end 517 and a back end. The housing 516 wraps over the upper portions of the drive wheel 106, tensioner wheel 112 and continuous track 114. The front end 517 and back end 517 close the housing 516 at either end. The front end 517 is coupled to the standing platform 102. A wheel support 518 comprises a wheel support member 519. The wheel support member 519 wraps around the base of the housing 516 and attaches to the standing platform 102. The wheel support member 519 is coupled to the drive wheel 106 and the tensioner wheel 112 on both of their sides.

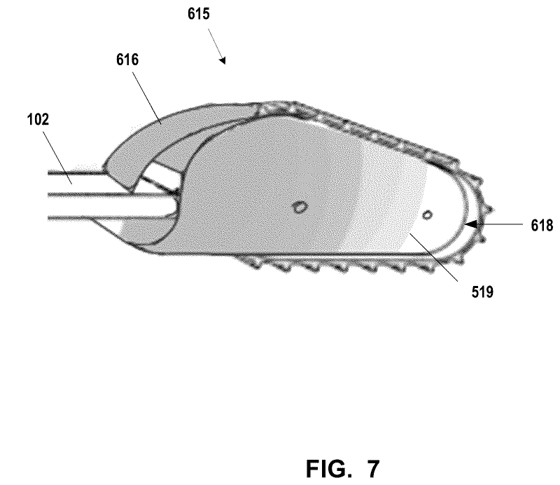

Referring to FIG. 7, illustrated therein is a track cover 615, according to an embodiment. The track cover 615 includes a flap 616. The flap 616 extends from the standing platform 102 and rearwards to at least partially cover the continuous track 114 and drive wheel 106. A wheel support 618 comprises a wheel housing 619. The wheel housing 619 is coupled to the drive wheel 106 and the tensioner wheel 112 on both of their sides. The wheel housing 619 is shaped to cover the sides of the drive wheel 106 and tensioner wheel 112. The wheel housing 619 wraps below the standing platform 102 to reach either side of the drive wheel 106 and tensioner wheel 112.

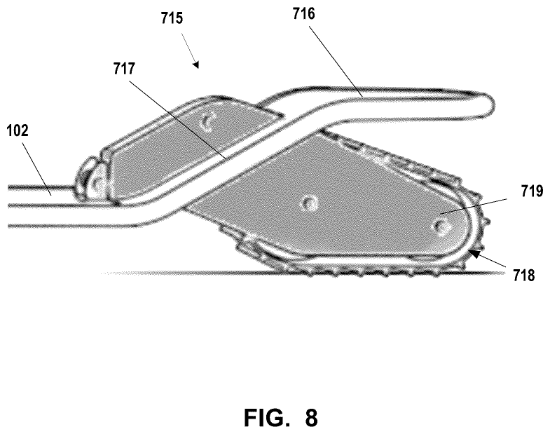

Referring to FIG. 8, depicted is a track cover 715, according to an embodiment. The track cover 715 includes a horizontal portion 716 and an angled portion 717. The angled portion 717 extends up and away from the top surface 104 of the standing platform 102, towards the track assembly 110. The horizontal portion 716 extends generally horizontally away from the angled portion 717 to at least partially cover the drive wheel 106 and continuous track 114. A wheel support 718 comprises a pair of side panels 719. The pair of side panels 719 are mounted to the track cover 715. The side panels 719 are coupled to the drive wheel 106 and the tensioner wheel 112 on both of their sides. The side panels 719 are shaped to cover the sides of the drive wheel 106 and tensioner wheel 112.

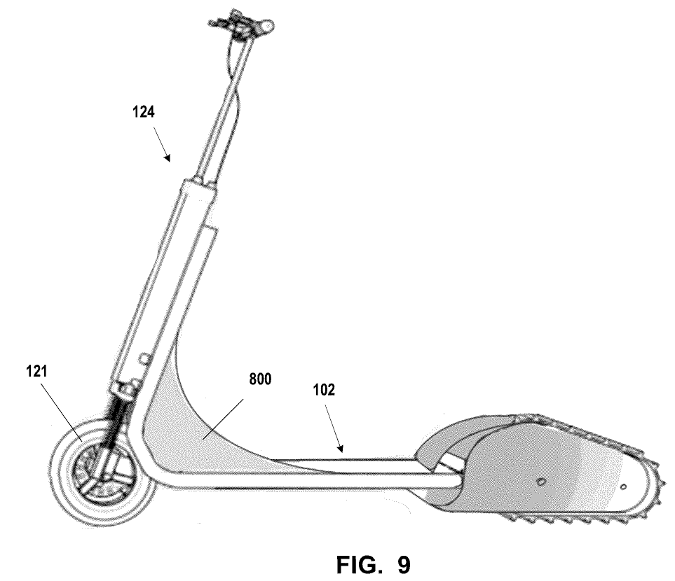

Referring to FIG. 9, illustrated therein is a pair of side guards 800, according to an embodiment. Each one of the pair of side guards 800 extend from one side of the standing platform 102 to one side of the handle assembly 124. The pair of side guards 800 prevent debris from being thrown onto the operator of the kick scooter 100 by the front wheel 121.

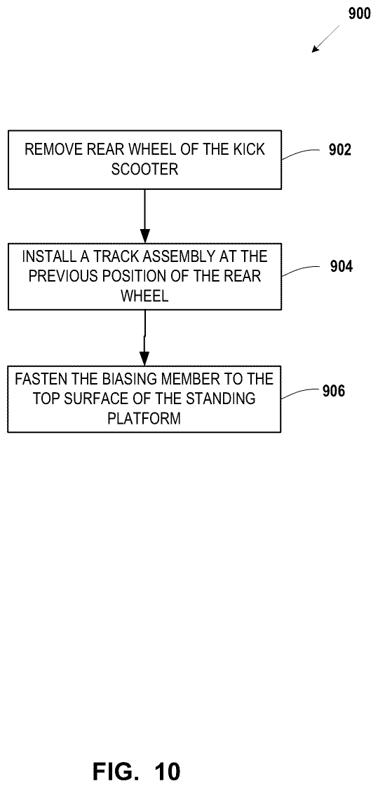

Referring to FIG. 10, illustrated therein is a method of converting a kick scooter from a wheeled configuration to a tracked configuration 900, in accordance with an embodiment. At 902, a rear wheel coupled to a standing platform (e.g. standing platform 102) is removed. At 904, a track assembly (e.g. track assembly 110) is installed at the previous position of the rear wheel. At 906, a biasing member (e.g. biasing member 120) is fastened to the top surface (e.g. top surface 104) of the standing platform.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

What is claimed is:

1. A kick scooter, comprising:
a standing platform for supporting an operator, the standing platform having a top surface;
a drive wheel coupled to the standing platform;
a track assembly, pivotably coupled to the standing platform, for propelling the kick scooter, the track assembly comprising:
a tensioner wheel; a continuous track that wraps around the tensioner wheel and the drive wheel, the continuous track being driven by the drive wheel and supported by the tensioner wheel;
a biasing member mounted to the top surface of the standing platform and coupled to the track assembly, for biasing the track assembly downwards; and
an electric motor for driving the drive wheel.

2. The kick scooter of claim 1, wherein the drive wheel has a rotational axis about which the drive wheel rotates, and wherein the track assembly pivots about the rotational axis of the drive wheel.

3. The kick scooter of claim 1, wherein the track assembly is positioned rearward of the standing platform.

4. The kick scooter of claim 1, wherein the electric motor is housed within the driving wheel.

5. The kick scooter of claim 1, wherein the tensioner wheel is a roller wheel.

6. The kick scooter of claim 1, wherein the drive wheel is a spoke wheel.

7. The kick scooter of claim 1, wherein the tensioner wheel promotes contact between the continuous track and drive wheel.

8. The kick scooter of claim 1, wherein the kick scooter further comprises a front wheel, coupled to the standing platform, for providing the operator with steering control and supporting the kick scooter.

9. The kick scooter of claim 1, wherein the kick scooter further comprises a front ski, coupled to the standing platform, for providing the operator with steering control and supporting the kick scooter.

10. The kick scooter of claim 1, wherein the biasing member comprises a coil spring.

11. The kick scooter of claim 1, wherein the biasing member comprises a damper.

12. A method of converting a kick scooter from a wheeled configuration to a tracked configuration, the kick scooter having:
a standing platform for supporting an operator, the standing platform having a top surface; a rear wheel coupled to the standing platform; and an electric motor for driving the rear wheel;
the method comprising:
removing the rear wheel of the kick scooter;
installing a track assembly at the previous position of the rear wheel, the track assembly comprising:
a drive wheel; a tensioner wheel; a continuous track that wraps around the tensioner wheel and the drive wheel, the continuous track being driven by the drive wheel and supported by the tensioner wheel; and a biasing member; and
fastening the biasing member to the top surface of the standing platform.
